(19) United States
(12) Patent Application Publication
(10) Pub. No.: US 2024/0133719 A1
(43) Pub. Date: Apr. 25, 2024

(54) CROSS-CORRELATION-BASED MANHOLE LOCALIZATION USING AMBIENT TRAFFIC AND FIBER SENSING

(71) Applicant: NEC Laboratories America, Inc., Princeton, NJ (US)

(72) Inventors: Milad SALEMI, Cross River, NY (US); Ming-Fang HUANG, Princeton, NJ (US); Shaobo HAN, Princeton, NJ (US); Yuheng CHEN, South Brunswick, NJ (US)

(73) Assignee: NEC Laboratories America, Inc., Princeton, NJ (US)

(21) Appl. No.: 18/485,223

(22) Filed: Oct. 11, 2023

Related U.S. Application Data
(60) Provisional application No. 63/415,685, filed on Oct. 13, 2022.

(51) Int. Cl. G01D 5/353; G01H 9/00

(52) U.S. Cl. CPC G01D 5/35361; G01H 9/004

(57) ABSTRACT

Systems and methods for manhole localization along deployed fiber optic cables that employs cross-correlation methodologies and ambient road traffic operating proximate to the manholes including fiber optic telecommunications cables to detect the manhole locations using distributed fiber optic sensing (DFOS). Advantageously the manhole locations are determined without employing labor intensive field surveys.

### CROSS-REFERENCE TO RELATED APPLICATIONS

This application claims the benefit of U.S. Provisional Patent Application Ser. No. 63/415,685 filed Oct. 13, 2022, the entire contents of which is incorporated by reference as if set forth at length herein.

### FIELD OF THE INVENTION

This application relates to fiber optic communications. More particularly, it pertains to distributed fiber optic sensing (DFOS) systems, methods, and structures as used in cross-correlation-based manhole localization using ambient traffic and fiber sensing.

### BACKGROUND OF THE INVENTION

In the last 30+years, telecommunications carriers and service providers have deployed more than 300 million miles of optical fibers. As is known to those skilled in the art, manholes are a convenient location to interconnect the deployed fibers and store splicing trays. Unfortunately, the precise location(s) of many manholes are not adequately documented, and paper records of such locations are oftentimes woefully inadequate and out of date. While manhole location determining methods have been developed by the carriers and service providers, such methods are oftentimes time consuming and labor intensive.

### SUMMARY OF THE INVENTION

The above problem is solved and an advance in the art is made according to aspects of the present disclosure directed to a manhole localization along deployed fiber optic cables. In sharp contrast to the prior art, our inventive method uses cross-correlation methodologies and ambient road traffic operating proximate to the manholes including fiber optic telecommunications cables to detect the manhole locations using distributed fiber optic sensing (DFOS).

In sharp contrast to the prior art, our inventive systems and methods determine the manhole locations without employing labor intensive field surveys.

### BRIEF DESCRIPTION OF THE DRAWING

A more complete understanding of the present disclosure may be realized by reference to the accompanying drawing in which:

FIG. 1(A) is a schematic diagram showing an illustrative DFOS system according to aspects of the present disclosure;

FIG. 1(B) is a schematic diagram showing an illustrative architecture for coherent-detection Rayleigh OTDR according to aspects of the present disclosure;

FIG. 2 is a schematic diagram showing an illustrative workflow of manhole localization according to aspects of the present disclosure;

FIG. 3(A) is a schematic diagram showing an illustrative system setup and traffic for automated manhole localization according to an aspect of the present disclosure;

FIG. 3(B) shows a pair of waterfall plots when a vehicle passes proximate to a manhole of

FIG. 3(A) according to an aspect of the present disclosure;

FIG. 4 is a schematic diagram showing an illustrative example of an implementation of cross correlation at sensing point j in a waterfall with 2 neighboring points (p=2) according to an aspect of the present disclosure;

FIG. 5(A), FIG. 5(B), and FIG. 5(C) show a set of plots used in the detection and localization of manholes using ambient traffic vibrations in which: FIG. 5(A) is an input waterfall showing vehicle trajectories with surveyed manhole locations at dashed lines; FIG. 5(B) shows a cross correlation map for the waterfall data with 200 time step segments and 10 neighbor points; and FIG. 5(C) shows resulting curve peaks that coincide with surveyed manhole locations at dashed lines; according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we begin by noting that distributed fiber optic sensing (DFOS) is an important and widely used technology to detect environmental conditions (such as temperature, vibration, acoustic excitation vibration, stretch level etc.) anywhere along an optical fiber cable that in turn is connected to an interrogator. As is known, contemporary interrogators are systems that generate an input signal to the fiber and detects/analyzes the reflected/scattered and subsequently received signal(s). The signals are analyzed, and an output is generated which is indicative of the environmental conditions encountered along the length of the fiber. The signal(s) so received may result from reflections in the fiber, such as Raman backscattering, Rayleigh backscattering, and Brillion backscattering. DFOS can also employ a signal of forward direction that uses speed differences of multiple modes. Without losing generality, the following description assumes reflected signal though the same approaches can be applied to forwarded signal as well.

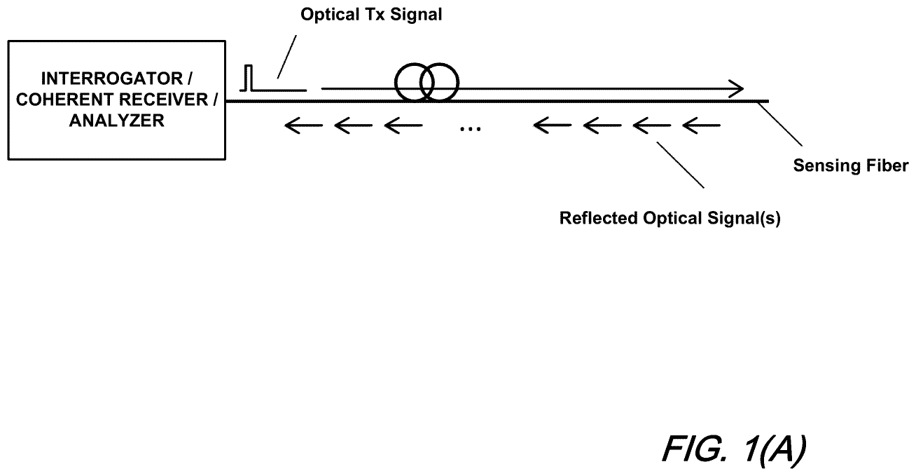

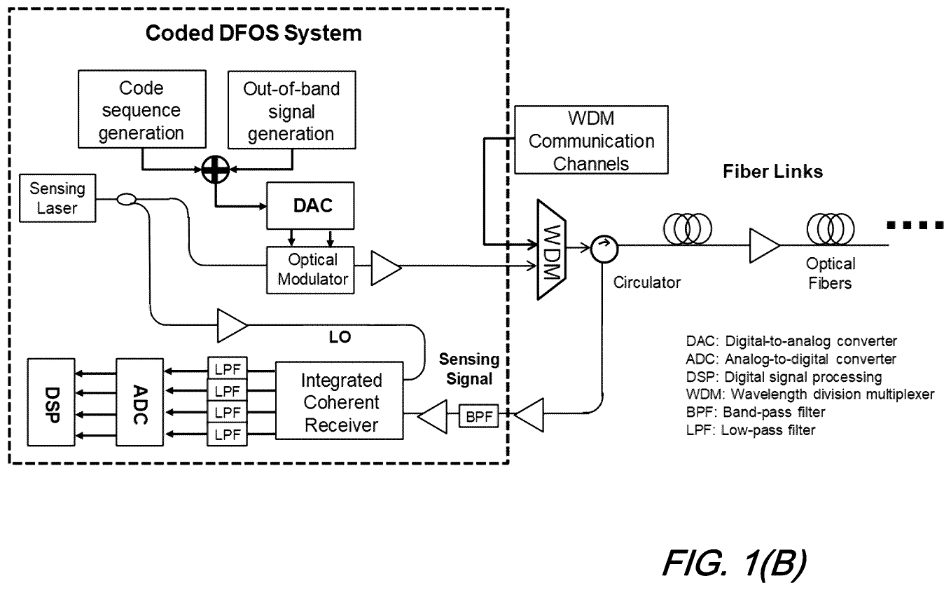

FIG. 1(A) is a schematic diagram of a generalized, prior-art DFOS system. As will be appreciated, a contemporary DFOS system includes an interrogator that periodically generates optical pulses (or any coded signal) and injects them into an optical fiber. The injected optical pulse signal is conveyed along the optical fiber.

At locations along the length of the fiber, a small portion of signal is reflected and conveyed back to the interrogator. The reflected signal carries information the interrogator uses to detect, such as a power level change that indicates—for example—a mechanical vibration. While not shown in detail, the interrogator may include a coded DFOS system that may employ a coherent receiver arrangement known in the art and shown illustratively in FIG. 1(B).

The reflected signal is converted to electrical domain and processed inside the interrogator. Based on the pulse injection time and the time signal is detected, the interrogator determines at which location along the fiber the signal is coming from, thus able to sense the activity of each location along the fiber.

As we shall show and describe, we use distributed fiber optic sensing (DFOS) technology and cross-correlation methodologies based on ambient traffic data along the fiber optic cable route for manhole localization.

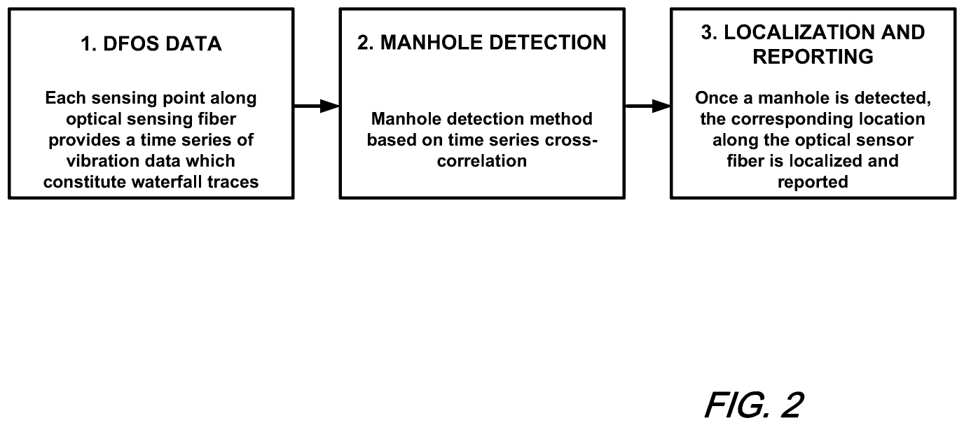

FIG. 2 is a schematic diagram showing an illustrative workflow of manhole localization according to aspects of the present disclosure. With reference to that figure, we observe that our inventive method employs DFOS sensor data. As those skilled in the art will understand and appreciate, DFOS provides a plurality of sensing points along the length of an optical sensor fiber that produces a time series of vibration data which constitute the waterfall traces. Cross correlation of the time series according to our inventive disclosure detects manholes along the optical sensor fiber route. Finally, once a manhole is detected, the corresponding location along the optical sensor fiber is localized and reported to appropriate persons.

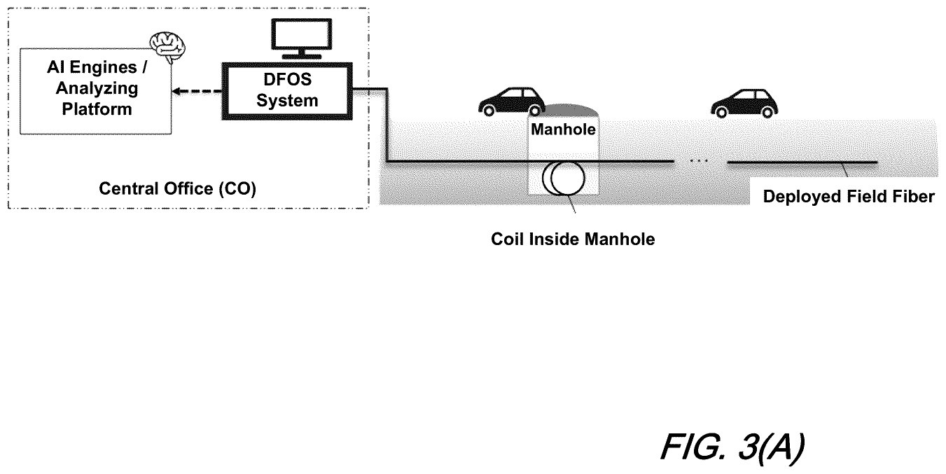

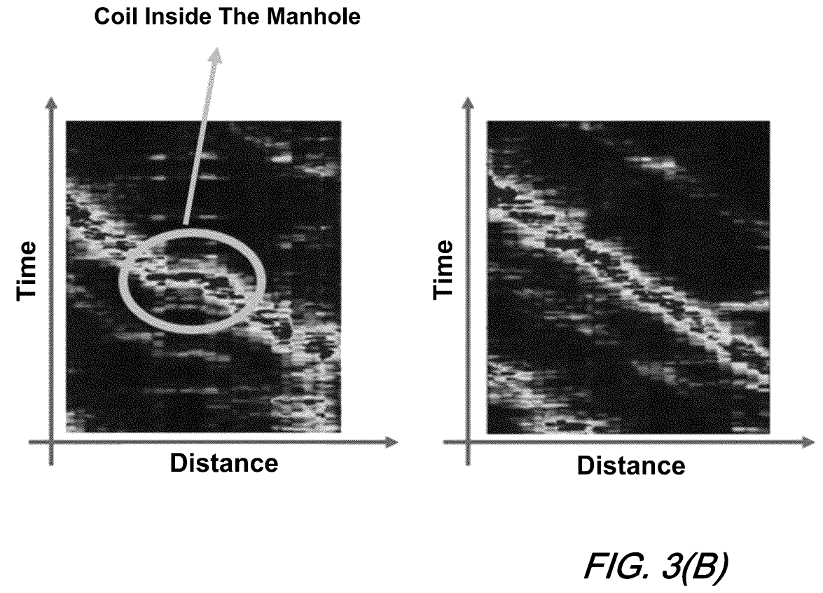

FIG. 3(A) is a schematic diagram showing an illustrative system setup and traffic for automated manhole localization according to an aspect of the present disclosure.

FIG. 3(B) shows a pair of waterfall plots when a vehicle passes proximate to a manhole of FIG. 3(A) according to an aspect of the present disclosure.

With simultaneous reference to these figures, one may observe the system setup and resultant waterfall traces. Advantageously, the DFOS system employed can be configured to perform either as distributed acoustic sensing (DAS) and/or distributed vibration sensing (DVS) and conveniently located in a central office (CO) for remote monitoring of an entire fiber optic cable route. As will be appreciated, such fiber optic cables include multiple individual optical fibers, any one of which may serve as an optical sensor fiber when optically connected to a DFOS interrogator. The DFOS is operated and ambient traffic operating proximate to the optical sensor fiber affect backscattered signals that are received/collected by the DFOS system for further analysis.

As shown in FIG. 3(B), a visualized plot of waterfall data representative of a situation with vehicle trajectories—the data received via DFOS operation—is indicative of vehicles operating proximate the optical sensor fiber interrogated by the DFOS system interrogator. As further shown in this figure are two scenarios. The first (right) plot exhibiting an uninterrupted continuous slope indicates no manhole presence in that route section. In sharp contrast, the plot on the left exhibits a horizontal shift in the vehicle trajectory that is visible and is indicative of a manhole in that route section.

As those skilled in the art will understand and appreciate, when a vehicle passes over a manhole, slack fiber located inside the manhole is collectively vibrated. Hence, it provides a vibrational signature for our inventive scheme, that further employs a cross correlation method to detect manhole locations along the optical sensor fiber route.

As will be appreciated by those skilled in the art, when a vehicle passes sufficiently close to a manhole (whether covered or uncovered) it will generate vibrations in the underground housing of the manhole which in turn causes an entire slack optical fiber loop located inside the manhole to vibrate simultaneously. According to aspects of the present disclosure, such synchronous vibrations created in the length of slack fiber loop(s) in the manhole identifies adjacent, neighboring sensing points along the length of the optical fiber loops, and therefore permits localization using cross-correlation of vibration time series at these neighboring points.

There are few design parameters that need considration to successfully use our cross correlation method for detecting cable loops and consequently manholes. These parameters are:

(1) What time segment for calculating cross correlation of time series should be used and how often to calculate cross correlations; and

(2) Over what extent of neighboring sensing points should we calculate these cross correlations ? At each sensing point, how many sesning points on the left and the right as determined along the length of the optical sensing fiber should be considered in cross corelation calculations.

For this approach to work effectively an estimated minumum of 5 m cable loop is required, which, depending on the spatial resolution used in DFOS system, could be one or two neighboring points on each side of a sensing point.

In general:

$${XCorr}_{j} = {\prod }_{i = - p}^{p} {C}_{j} ⊗ {C}_{j + i}$$

Where Cⱼ denotes vibration time series segment (waterfall column) at sensing point j, and XCorrⱼ is the product of cross correlation values of p neigboring sensing points to the left and right.

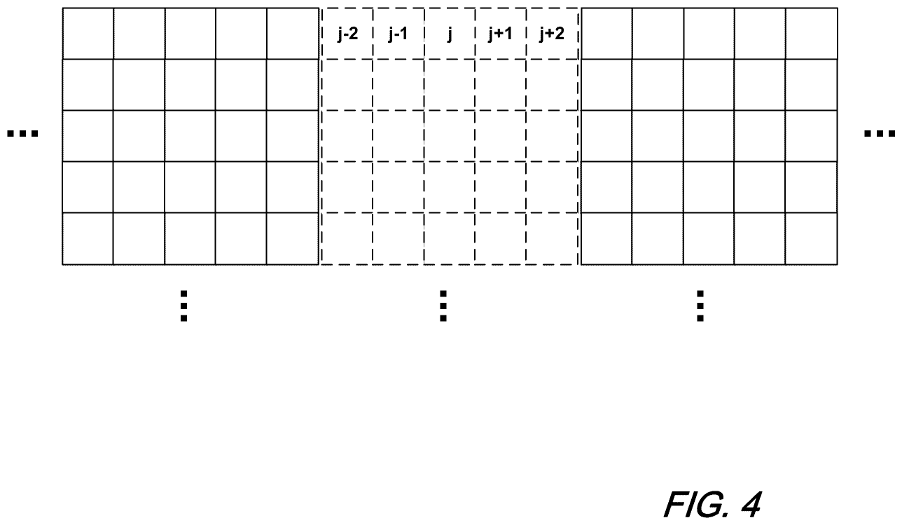

FIG. 4 is a schematic diagram showing an illustrative example of an implementation of cross correlation at sensing point j in a waterfall with 2 neighboring points (p=2) according to an aspect of the present disclosure.

(3) Depending on the generated cross correlation map, different statistical indicators such sum, median, mean, or maximum is used to account for coumpund effect of cross correlations values and isolate mid-point of the cable loop which estimates location of manhole.

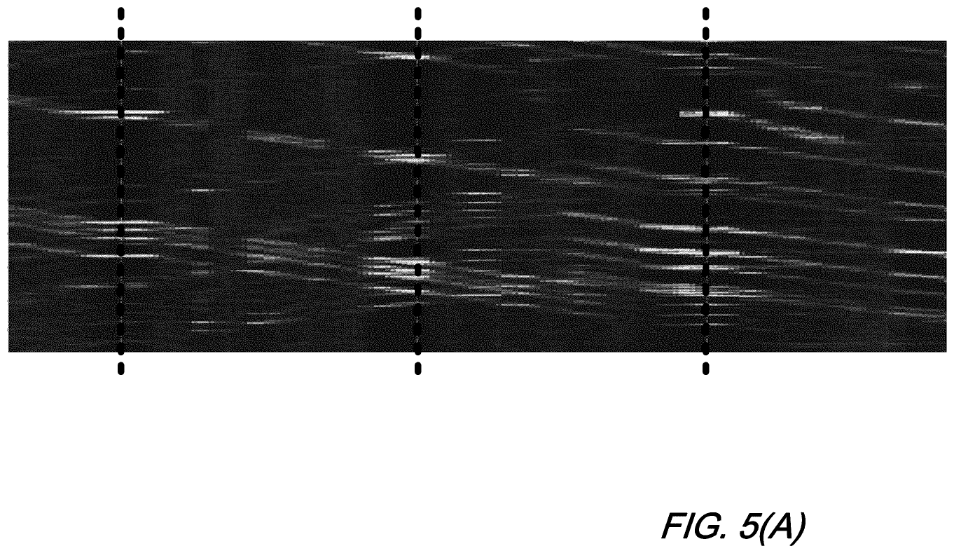

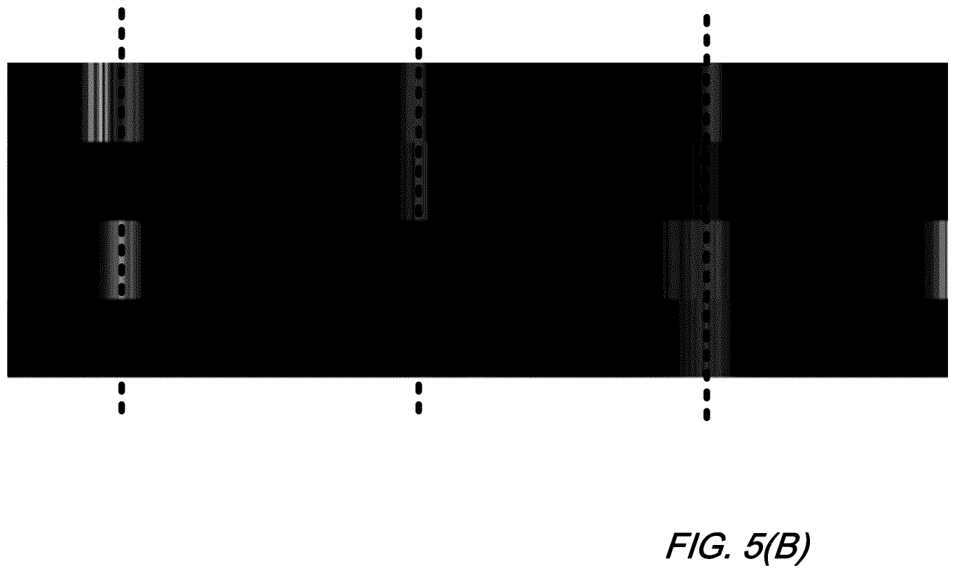

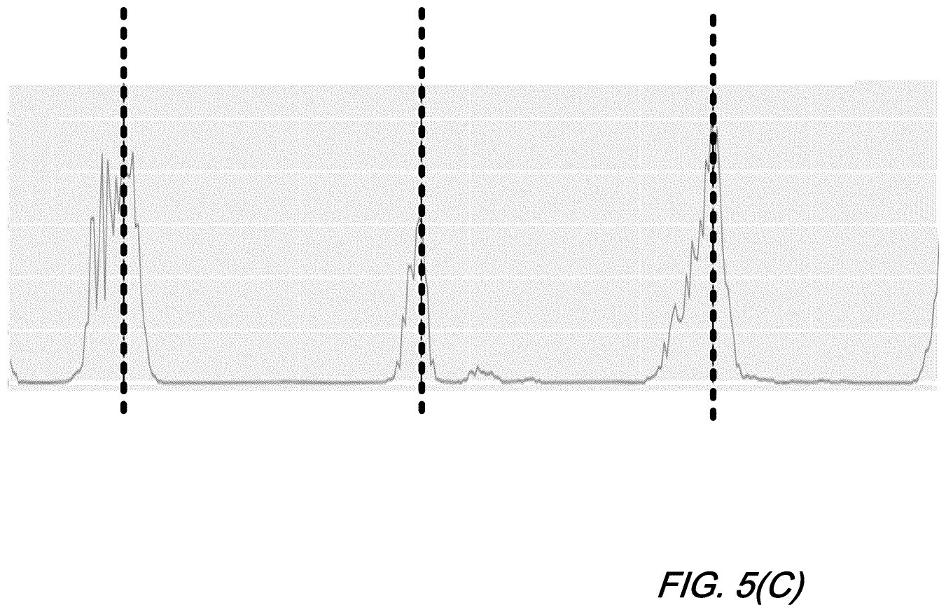

FIG. 5(A), FIG. 5(B), and FIG. 5(C) show a set of plots used in the detection and localization of manholes using ambient traffic vibrations in which: FIG. 5(A) is an input waterfall showing vehicle trajectories with surveyed manhole locations at dashed lines; FIG. 5(B) shows a cross correlation map for the waterfall data with 200 time step segments and 10 neighbor points; and FIG. 5(C) shows resulting curve peaks that coincide with surveyed manhole locations at dashed lines; according to aspects of the present disclosure.

FIG. 5(A) is an example of field traffic data in a road section. Vertical dashed lines in that figure are the surveyed locations of manholes. After processing through our inventive methods, mid points of cable loops which corresponds to manhole location forma a peak as illustratively shown in FIG. 5(C).

It is clear from the waterfall plot shown illstratively in FIG. 5(A), that vehicle trajectores as detected by DFOS are intensifed when passing close to manholes containg loops of slack optical sensing fiber and generate a wide horizontal region that is proportional to the length of slack fiber located inside the manhole so passed by the vehicles.

At this point, while we have presented this disclosure using some specific examples, those skilled in the art will recognize that our teachings are not so limited. Accordingly, this disclosure should only be limited by the scope of the claims attached hereto.

1. A cross-correlation-based manhole localization method using ambient traffic and fiber sensing, the method comprising:
collecting, using a distributed fiber optic sensing (DFOS) system, sensing signals that include ambient traffic noise and generating, from the collected sensing signals, sensing test data;
identifying, using cross-correlation of the sensing test data, DFOS locations indicative of manhole and non-manhole locations; and
outputting an indicium of the manhole and non-manhole locations.

2. The method of claim 1 wherein the cross-correlation is applied to 1 or more neighboring points of a sensing point along an optical sensor fiber in optical communication with the DFOS system.

3. The method of claim 1 further comprising:
identifying, in the sensing test data, DFOS locations indicative of fiber loop locations.

4. The method of claim 3 further comprising:
estimating the length of the identified fiber loops.
